(19) United States
(12) Patent Application Publication
(10) Pub. No.: US 2006/0193121 A1
(43) Pub. Date: Aug. 31, 2006

(54) Light-emitting diode device and method of manufacturing thereof

(75) Inventor: Shohichi Kamoshita, Yamatokoriyama-Shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/365,560

(22) Filed: Feb. 28, 2006

(30) Foreign Application Priority Data
Feb. 28, 2005 (JP) 2005-054141

(51) Int. Cl. F21V 9/16

(52) U.S. Cl. 362/84; 362/260; 362/800

(57) ABSTRACT

An LED device that is excellent in color mixture and small in variation of chromaticity is provided. The LED device includes, in a package, an LED chip, a fluorescent material excited by light from the LED chip to generate light with a wavelength different from that of the light from the LED chip, and a translucent resin holding the fluorescent material. The LED chip has a side-surface portion, a top-surface portion, a bottom-surface portion, and a light-emitting layer sandwiched between the top-surface portion and the bottom-surface portion, and the fluorescent material in the translucent resin is provided in a layer form on a bottom surface of the package to entirely or partially cover the side-surface portion of the LED chip.

This nonprovisional application is based on Japanese Patent Application No. 2005-054141 filed with the Japan Patent Office on Feb. 28, 2005, the entire contents of which are hereby incorporated by reference.

### BACKGROUND OF THE INVENTION

1. Field of the Invention

The present invention relates to a light-emitting diode device used in such applications as backlight of a liquid-crystal display, a panel meter and an indicator light. In particular, the invention relates to white and intermediate-color light-emitting diode devices and a method of manufacturing thereof.

2. Description of the Background Art

A conventional light-emitting diode (hereinafter also referred to as “LED”) has a device structure as shown in FIGS. 10A and 10B. As shown in FIGS. 10A and 10B, the LED device includes, within its package 14, an LED chip 11, a fluorescent material 18 excited by light from LED chip 11 to generate light with a different wavelength, and a translucent resin 17. LED chip 11 is mounted via an electrically-conductive material 13 on a pair of positive and negative electrodes 15, 16. To LED chip 11, a wire 12 for supplying electric current is provided.

As disclosed in Japanese Patent Laying-Open Nos. 2004-221163 and 2003-179269, translucent resin 17 to be injected is mixed with a light-diffusing agent 19 containing silica (SiO₂) as a component for example with the purpose of improving color mixture of light emitted from LED chip 11 and light emitted from fluorescent material 18. In order to avoid unevenness of the color mixture, it is necessary to allow a uniform amount of fluorescent material to be enclosed in the package and allow the fluorescent material to be districted evenly therein. Accordingly, as disclosed in Japanese Patent Laying-Open No. 2003-258310, such a method has been proposed as the one using the ink-jet scheme to form a fluorescent-material layer or using the sputtering to form a fluorescent-material layer. Actually, however, a generally-employed method in view of cost and easy application to a wide variety of products is to use the dispense method to inject a translucent resin containing a fluorescent material into a package.

A generally-employed LED chip has, as shown in FIG. 9A, a sapphire substrate 99 on which nitride semiconductor layers 90, 98 are formed, and a light-emitting layer 97 is located in an upper portion of the LED chip with respect to the direction of the thickness of the LED chip. Further, the chip has its top surface where a pair of positive and negative electrodes 95, 96 is provided. To the electrodes, metal wires are connected for supplying electric current.

For the LED device mixing the color of light from the LED and the color of light from the fluorescent material to obtain a desired color, what is important is how to uniformly mix the colors and how to prevent variation in chromaticity of the color-mixed light.

Currently, a generally-employed light-emitting diode device is a combination of a high-brightness blue LED chip and a fluorescent material that is excited by the light from the blue LED chip to emit yellow light, and respective colors from the chip and the fluorescent material are mixed to generate a desired white-based color. The LED chip used here is, in most cases, in the shape of a rectangular solid including a sapphire substrate and nitride semiconductor layers deposited on the substrate to form a light-emitting portion. It is supposed here as shown in FIG. 9B that the direction orthogonal to the top surface of the LED chip is 0°. A relation between the luminous-intensity-distribution angle and the relative luminous intensity of emitted light is shown in FIG. 9C. As clearly seen from FIG. 9C, the emission in the direction orthogonal to the top surface of the LED chip has the highest brightness. As the angle of emission increases with respect to the angle of the direction orthogonal to the top surface, the brightness of the emission gradually decreases.

FIG. 10B shows another conventional LED device that is different in structure from the LED device shown in FIG. 10A. Regarding the LED device shown in FIG. 10B, an injected translucent resin 17 contains a granular anti-settling agent 19 with the purpose of preventing a fluorescent material 18 from settling. The structure of fluorescent material 18 in the LED device is roughly classified into the type as shown in FIG. 10A where fluorescent material 18 is provided at the bottom of package 14 and the type as shown in FIG. 10B where fluorescent material 18 is scattered in translucent resin 17. In the case where an LED chip having the radiation characteristics as shown in FIG. 9C is used, however, the following problem arises.

As shown in FIG. 10A for example, from the device of the type having fluorescent material 18 at the bottom of package 14, it is difficult to derive a favorable color mixture. This is because the amount of fluorescent material distributed near the top surface where the radiation brightness is the highest is relatively small relative to the amount of light emitted from the LED chip. In order to obtain a favorable color mixture, it is desirable to allow the amount of the fluorescent material to be distributed in proportion to the amount of light emitted from the chip. Actually, however, it is difficult to provide a relatively large amount of the fluorescent material in the region near the top surface of the chip where the amount of light is large and provide a relatively small amount of the fluorescent material in the region near the bottom surface of the package where the amount of light is small. Accordingly, regarding the LED device of the type as shown in FIG. 10A, when the light-emitting surface of the LED device is observed, the light from the LED chip is intense in a central region of the light-emitting surface while the light from the fluorescent material is intense in the surrounding region. Thus, in this case, it is difficult to obtain a favorable color mixture.

In order to improve the above-described state, a method may be employed, as shown in FIG. 10A, by which such a granular light-scattering agent 19 as silica (SiO₂) is provided in translucent resin 17 over the layer of fluorescent material 18 in order to scatter the light. The light-scattering agent, however, absorbs a considerable amount of light while reflecting light. Therefore, as a whole, the light extraction efficiency of the LED device is lowered. For example, in the case where silica (SiO₂) which is known as a general light-scattering agent is used, the light extraction efficiency of the device decreases by approximately 10 to 20%, which is experimentally confirmed.

A commonly-used rare-earth-based granular fluorescent material is higher in specific gravity than an epoxy-based resin or silicon-based resin that is employed as the translucent resin. Therefore, in order to arrange the fluorescent material at the bottom of the package, a method is used by which the translucent resin mixed with the fluorescent material is injected into the package and thereafter the translucent resin is heated to be cured after the fluorescent material settles. However, even in the process of injecting the resin, the fluorescent material is settling in the container used for the injection. Therefore, it is difficult to inject a uniform amount of the fluorescent material into the package. Consequently, variation in chromaticity of the color mixture occurs. Further, since the settling fluorescent material does not as it is form a layer with an even thickness at the bottom of the package, which also leads to a factor of the variation in chromaticity.

As for the LED device of the type shown in FIG. 10B where fluorescent material 18 is scattered in translucent resin 17, it is difficult to uniformly distribute the fluorescent material within the package. Consequently, the chromaticity of the color-mixed light varies to a greater extent. This is due to the difference in specific gravity as described above which allows the fluorescent material to settle within the translucent resin. Thus, the fluorescent material is settling in the injection container in the injection process, leading to difficulty in injection into the package at an even concentration.

Further, at an initial stage of the process of heating and curing after the injection, the viscosity of the translucent resin decreases, which promotes the settling of the fluorescent material. Thus, it is difficult to keep constant the concentration of the fluorescent material injected into the package and it is also difficult to uniformly arrange and distribute the fluorescent material within the package. Therefore, it is likely that the chromaticity of the color-mixed light is uneven. In order to overcome these disadvantages, an anti-settling agent may be mixed into the translucent resin together with the fluorescent material to increase the viscosity of the translucent resin and thereby prevent settlement of the fluorescent material. However, since the anti-settling agent is also comprised of superfine particles like silica (SiO₂), absorption of light as well as resultant deterioration in light extraction efficiency of the LED device occur, as occurs in the case where the aforementioned light-scattering agent is used.

### SUMMARY OF THE INVENTION

An LED device that is excellent in color mixture and small in variation of chromaticity is provided. A light-emitting diode device according to an aspect of the present invention includes, in a package, a light-emitting diode chip, a fluorescent material excited by light from the light-emitting diode chip to generate light with a wavelength different from that of the light from the light-emitting diode chip, and a translucent resin holding the fluorescent material. The light-emitting diode chip has a side-surface portion, a top-surface portion, a bottom-surface portion, and a light-emitting layer sandwiched between the top-surface portion and the bottom-surface portion, and the fluorescent material in the translucent resin is provided in a layer form on a bottom surface of the package to entirely or partially cover the side-surface portion of the light-emitting diode chip.

Regarding the light-emitting diode device of the present invention, according to another aspect, the fluorescent material in the translucent resin is provided in the layer form on the bottom surface of the package to have a uniform thickness from the bottom surface. Further, regarding the light-emitting diode device of the present invention, according to still another aspect, as shown in FIG. 4C, the translucent resin includes one translucent resin layer 47a provided on the bottom surface of the package and in a layer form and containing a fluorescent material and another translucent resin layer 47a provided adjacent to the translucent resin layer 47a and closer to an opening of the package and containing no fluorescent material.

Preferably, the light-emitting diode chip has its side-surface portion with an inclined surface so that the LED chip is convex toward the opening of the package. More preferably, the inclined surface is closer to the opening of the package relative to the light-emitting layer of the light-emitting diode chip. Preferably, the fluorescent material is in a form of particles and the particle size of the particles is selected to be within a range of ±50% of the median of the particle size of the particles. Further, the fluorescent material may be comprised of at least two types of fluorescent material emitting light with respective wavelengths different from each other by the light from the light-emitting diode chip. Preferably, the thickness of the layer including the fluorescent material in the translucent resin is smaller than the thickness from the bottom-surface portion to the top-surface portion of the light-emitting diode chip and larger than the thickness from the bottom-surface portion to the light-emitting layer of the light-emitting diode chip.

A method of manufacturing a light-emitting diode device of the present invention is a method of manufacturing the above-described light-emitting diode device, including the steps of injecting a translucent resin containing a fluorescent material into a package, applying vibrations to the package to form a flat layer including the fluorescent material on a bottom surface of the package, and heating to cure the translucent resin. Preferably, the step of injecting the translucent resin containing the fluorescent material into the package includes the steps of leaving an injection container filled with the fluorescent material and the translucent resin in a stationary state to allow the fluorescent material to settle in the translucent resin, and injecting the translucent resin including the settling fluorescent material into the package.

In accordance with the present invention, the LED device can be provided without deterioration in light extraction efficiency, having favorable color mixture and small variation in chromaticity of the color-mixed light. Further, since such agents as light-scattering agent and anti-settling agent are not used, the product cost is low and the production line can be simplified. Furthermore, the LED device is easy applicable to small-volume manufacturing of a wide variety of products.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 2B are perspective views and cross-sectional views each showing the structure of an LED device of the present invention.

FIGS. 3A and 3B are perspective views each showing the shape of an LED chip of the LED device of the present invention.

FIG. 4A is a perspective view of an LED chip of the LED device of the present invention.

FIG. 4B shows brightness characteristics of the LED chip shown in FIG. 4A.

FIG. 4C schematically shows movements of light of the LED device of the present invention.

FIG. 5 is a cross-sectional view of a fluorescent layer in the case where the fluorescent material includes a mixture of fluorescent-material particles different in particle size.

FIGS. 6A and 6B each schematically show a state where a layer of the fluorescent material is formed in the package.

FIG. 7 is a cross-sectional view of a resin-injection container.

FIGS. 8A to 8C each schematically show a state where a layer of the fluorescent material is formed in the package.

FIGS. 9A to 9C show an LED chip and its radiation characteristics of a conventional LED device.

FIGS. 10A and 10B each show a cross section of the structure of a conventional LED device.

### DESCRIPTION OF THE PREFERRED EMBODIMENTS

LED Device

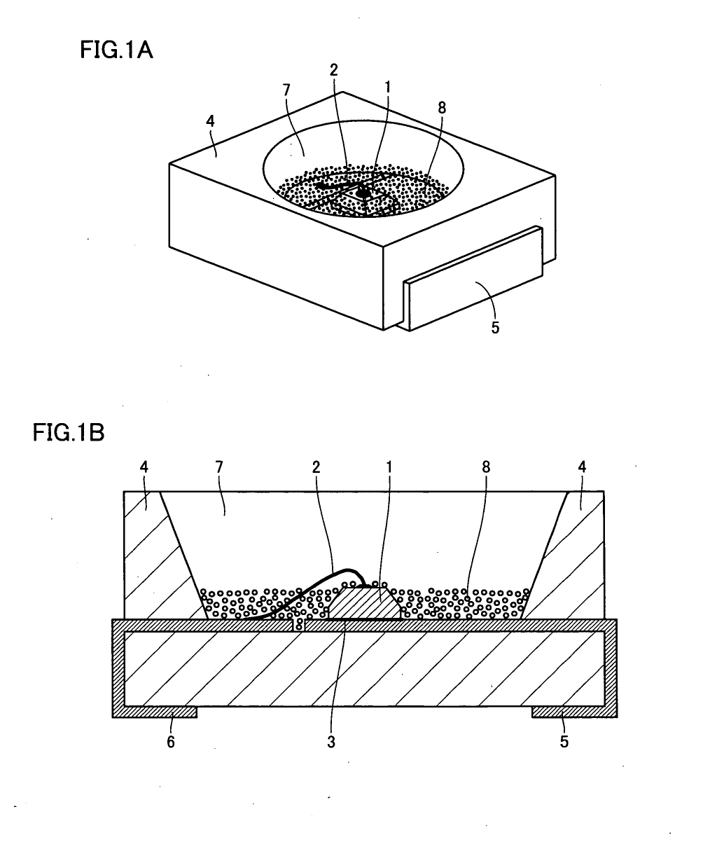

FIG. 1A is a perspective view of a surface-mounted light-emitting diode device as a typical example of the LED device of the present invention. FIG. 1B is a cross-sectional view of the LED device. The device includes a pair of positive and negative electrodes 5, 6 formed of a metal plate and a package 4 made of a heat-resistant resin. Package 4 can be formed by the insert molding and is in the shape of a reflection cup. An LED chip 1 has a side-surface portion and a top-surface portion and a part of the side-surface portion is an inclined surface. LED chip 1 is electrically connected within package 4 to one electrode 5 through an electrically conductive material 3 and to the other electrode 6 by a metal wire 2.

Package 4 is sealed with a translucent resin 7 and, near its bottom surface, a fluorescent material 8 is provided in a layer form with a substantially uniform thickness. The layer of fluorescent material 8 is formed to cover a part or the whole of the inclined surface of the side-surface portion of LED chip 1. In the example shown in FIG. 1B, a thin layer of fluorescent material 8 is located on the top surface of LED chip 1, however, the present invention includes an embodiment in which the fluorescent material is not provided on the top surface of the chip. Although translucent resin 7 located over the layer of fluorescent material 8 does not contain a light-scattering agent for diffusing light and an anti-settling agent for preventing settlement of the fluorescent material, the resin may contain a slight amount of fluorescent material, a pigment for adjusting the chromaticity and the like.

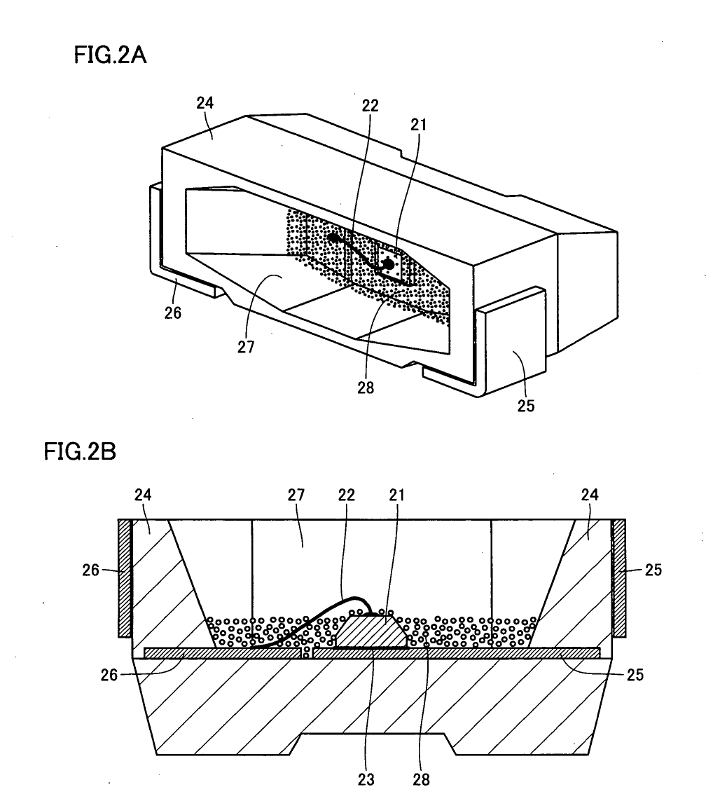

Another typical example of the LED device of the present invention is shown in FIGS. 2A and 2B. FIG. 2A is a perspective view and FIG. 2B is a cross-sectional view. The device here is identical in basic structure to the device shown in FIGS. 1A and 1B, while the former device is an LED device of the type radiating light in the direction orthogonal to the side surface with respect to the surface of the substrate on which the chip is mounted. The LED device includes a pair of positive and negative electrodes 25, 26 and a package 24. An LED chip 21 has a side-surface portion and a top-surface portion and a part of the side-surface portion is an inclined surface. LED chip 21 is connected to electrode 25 through an electrically-conductive material 23 and to electrode 26 by a metal wire 22. Package 24 is sealed with a translucent resin 27 and has a layer of a fluorescent material 28 near its bottom surface. The layer of fluorescent material 28 is formed to cover a part or the whole of the inclined surface of the side-surface portion of LED chip 21.

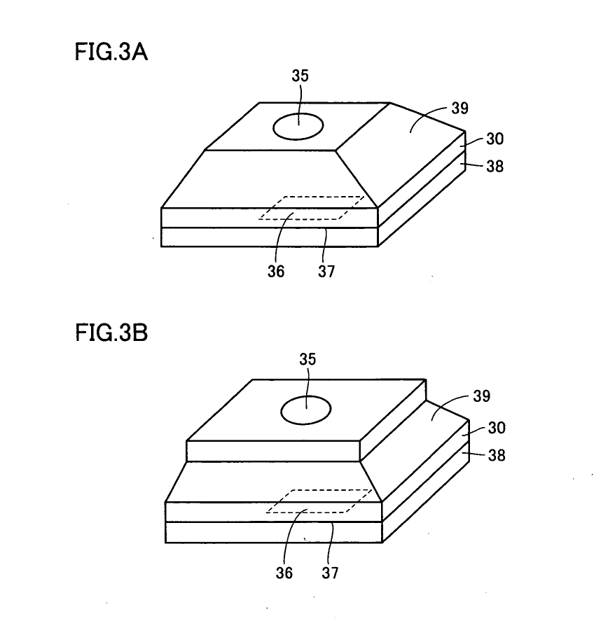

In the LED device of the present invention, preferably the LED chip includes a side-surface portion, a top-surface portion, a bottom-surface portion and a light-emitting layer sandwiched between the top-surface portion and the bottom-surface portion, and the side-surface portion has an inclined surface so that the LED chip is convex toward an opening of the package. FIGS. 3A and 3B each exemplarily show an LED chip used for the LED device of the present invention. The LED chip in FIG. 3A and the LED chip in FIG. 3B are only different in the shape of the side-surface portion and are identical to each other in the structure of the semiconductor layer. The chips are each structured to have, on a surface of an SiC substrate 39, an n-type nitride semiconductor layer 30 and a p-type nitride semiconductor layer 38 deposited successively in this order, have its top-surface portion where a negative electrode 35 is provided, and have its bottom-surface portion where a positive electrode 36 is provided. A light-emitting layer 37 is in the state of being sandwiched between the top-surface portion and the bottom-surface portion and at the interface between n-type semiconductor layer 30 and p-type semiconductor layer 38, and positioned closer to the bottom-surface portion with respect to the thickness of the LED chip.

As for the shape of the LED chip, both of the shape as shown in FIG. 3A having the entirely inclined side-surface portion of SiC substrate 39 and the shape as shown in FIG. 3B having the partially inclined side-surface portion of SiC substrate 39 are included in the present invention. Further, in these examples, the inclined surface is located closer to the top-surface portion relative to light-emitting layer 37. Namely, the inclined surface is located closer to the opening of the package relative to the light-emitting layer. The shape of the inclined surface can arbitrarily be adjusted by adjusting the angle of the shape of the tip of the cutting blade when the chip is cut from a wafer in the manufacturing process of the LED chip.

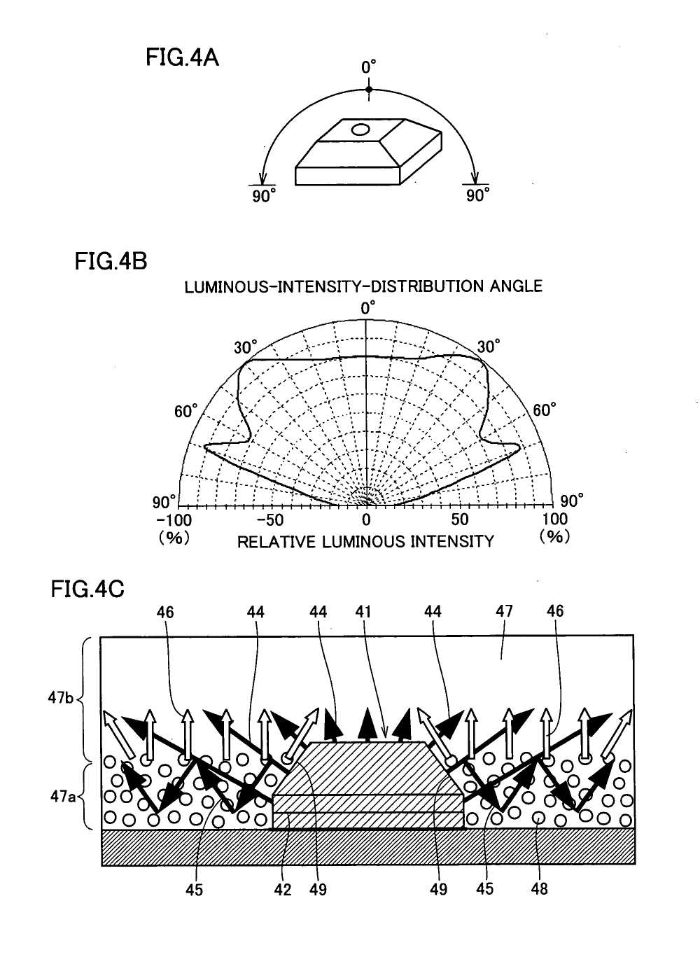

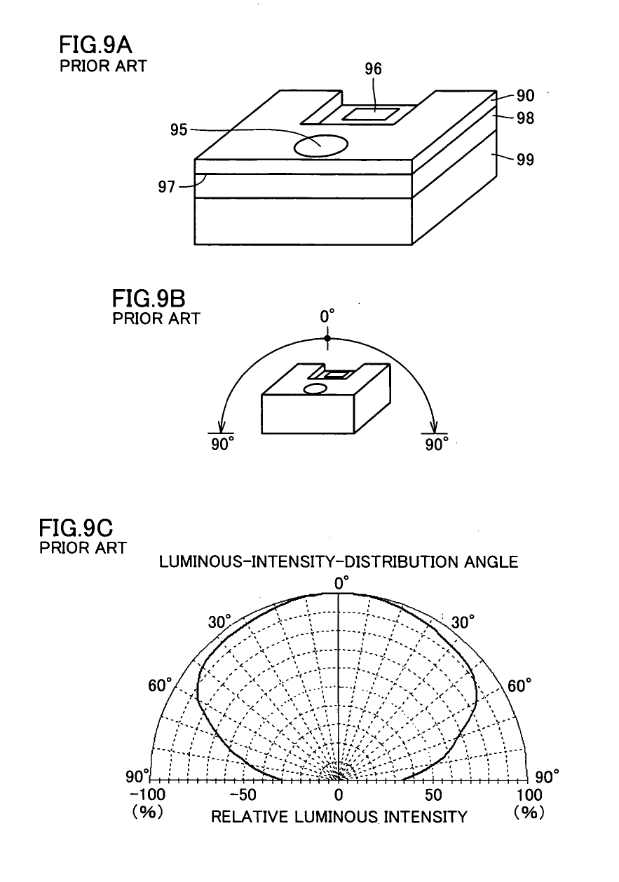

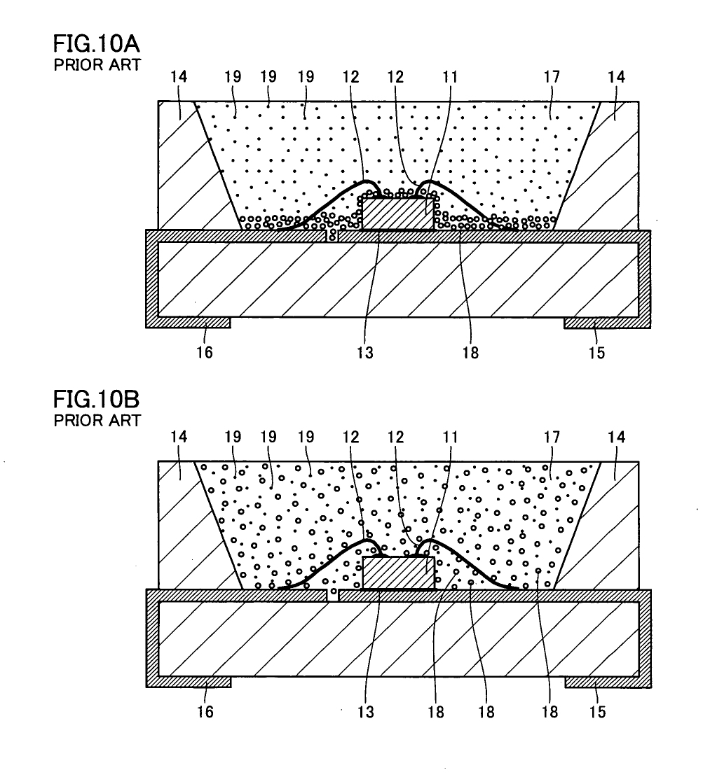

It is supposed here that, for the LED chip structured to have the inclined surface as shown in FIG. 4A, the direction orthogonal to the top surface of the LED chip is at a luminous-intensity-distribution angle of 0° and the direction orthogonal to the side surface of the LED chip is at a luminous-intensity-distribution angle of 90°. The brightness characteristics of the radiation at each luminous-intensity-distribution angle are represented by a relative luminous intensity in FIG. 4B. As shown in FIG. 4B, the peak is found around the luminous-intensity-distribution angle 40° and around the angle 70°, corresponding to the obliquely upward direction of the LED chip, and thus a relatively large amount of light is emitted in these directions. In contrast, as clearly seen from a comparison between the relative luminous intensity in FIG. 4B and that in FIG. 9C, the amount of light emitted around the luminous-intensity-distribution angle 0° is relatively small.

The LED chip with its side-surface portion having an inclined surface so that the LED chip is convex toward the opening of the package, namely toward the top-surface portion of the LED chip can have radiation characteristics of decreasing the radiation in the direction orthogonal to the top surface of the chip and increasing the radiation in the obliquely upward direction and the direction orthogonal to the side surface of the chip. This tendency is stronger for the type of the LED chip having the side-surface portion with the inclined surface positioned closer to the opening of the package relative to the light-emitting layer of the LED chip.

The above-described tendency of radiation characteristics does not depend on the materials of which the substrate and the semiconductor constituting the LED chip are made. For example, in the case as shown in FIG. 9A where n-type nitride semiconductor layer 98 and p-type nitride semiconductor layer 90 are successively deposited on sapphire substrate 99 and the LED chip has its top-surface portion where negative electrode 96 and positive electrode 95 are provided, bumps may be formed at the two electrodes on the top surface and the chip may be mounted by being turned upside down by means of flip bonding. Then, light-emitting layer 97 is located closer to the bottom surface with respect to the thickness of the chip. Accordingly, the side surface of sapphire substrate 99 located over light-emitting layer 97 may be inclined to achieve similar radiation characteristics to those of the present invention.

Preferably, the fluorescent material is formed to cover the whole or a part of the side-surface portion of the LED chip and provided in a layer form on the bottom surface of the package. The fluorescent layer can be formed to cover the side-surface portion including the inclined surface of the LED chip to efficiently take into the layer of the fluorescent material the light emitted in the obliquely upward direction and the direction orthogonal to the side surface of the LED chip. Then, the LED radiation taken into the fluorescent layer is repeatedly reflected. Each time the reflection occurs, the fluorescent material can be excited to generate fluorescent radiation.

The above-described state is shown in FIG. 4C. FIG. 4C schematically shows movements of light, and such components as the package and metal wires for electrical connection are not shown. In FIG. 4C, an inclined surface 49 of an LED chip 41 is covered with a fluorescent layer comprised of a fluorescent material 48 and a translucent resin 47 serving as a binder. As shown in FIG. 4C, fluorescent material 48 in translucent resin 47 is provided on the bottom surface of the package in a layer form with a uniform thickness from the bottom surface. This state may be taken from another aspect, namely translucent resin 47 includes one translucent resin layer 47a provided in a layer form on the bottom surface of the package and containing fluorescent material 48 and another translucent resin layer 47b provided adjacent to the translucent resin layer 47a and closer to the opening of the package and containing no fluorescent material 48. Since a light-emitting layer 42 is located near the bottom surface of the chip, the light-emitting layer is also covered with the fluorescent layer. Therefore, of the light emitted from light-emitting layer 42 of LED chip 41, most of the light emitted obliquely upward and in the direction orthogonal to the side surface is temporarily taken and held in the fluorescent layer. A part 44 of the light taken in the fluorescent layer is transmitted through the fluorescent material while a part 45 thereof is irregularly reflected from fluorescent material 48 in the fluorescent layer. Each time the reflection occurs, the fluorescent material is excited to cause fluorescent radiation 46 to be generated.

The fluorescent material may or may not be provided on the top-surface portion of the LED. In the case where the fluorescent material is provided on the top-surface portion, the fluorescent particle layer on the top-surface portion may be thinner than the fluorescent particle layer provided on the side-surface portion. As shown in FIG. 4B, the brightness characteristics of the LED chip of the present invention is that the light emitted in the direction orthogonal to the top surface of the LED chip is weak while the light emitted obliquely upward and in the direction orthogonal to the side surface is intense. Therefore, as shown in FIG. 4C, translucent resin 47 may have layer 47a comprised of fluorescent material 48 and having the thickness that is smaller than the thickness from the bottom-surface portion to the top-surface portion of LED chip 41 and that is larger than the thickness from the bottom-surface portion to light-emitting layer 42 of the LED chip. Accordingly, when the light-emitting surface of the LED device is viewed, the LED radiation from the central top-surface portion is not dominantly visible and thus the color of the LED radiation and the color of the fluorescent radiation can favorably be mixed. Thus, it is unnecessary that a light-scattering agent or anti-settling agent is contained in the translucent resin layer in the upper portion of the fluorescent layer for the purpose of improving color mixture. Favorable color mixture can thus be achieved without deteriorating light extraction efficiency and the manufacturing cost can be reduced.

The fluorescent material is preferably in the form of particles and preferably the particle size is within the range of ±50% of the median of the particle size of the particles. The present invention is based on the manner in which the light emitted from the LED chip is repeatedly reflected within the fluorescent layer to excite the fluorescent material. Therefore, preferably the fluorescent material to be used is granular or in the form of particles. Here, as shown in FIG. 5, if some particles are large and some particles are small in particle size in the fluorescent material, gaps in the upper portion of the fluorescent layer comprised of large-sized fluorescent-material particles 57 are closed by small-sized fluorescent-material particles 58, resulting in deterioration in light extraction efficiency from the fluorescent layer. In particular, in the case where settlement of the fluorescent material in the translucent resin is used to form the fluorescent layer, small-sized fluorescent-material particles slowly settle so that the state shown in FIG. 5 is likely to occur. For this reason, preferably the particle size of the fluorescent particles is selected to be within the range of ±50% of the median of the particle size of the particles of the fluorescent material. More preferably, the particle size of the fluorescent particles is selected to be within the range of ±30% of the median of the particle size of the fluorescent particles.

The fluorescent layer preferably has appropriate gaps. In the case where the LED chip is around 100 μm in thickness, an appropriate median of the particle size of the fluorescent particles is approximately 3 μm to 30 μm. Further, an inorganic fluorescent material like a rare-earth fluorescent material, which is a representative inorganic fluorescent material, is a preferable fluorescent material because of the particle form and less degradation.

The fluorescent material may be at least two types of fluorescent material generating light with different wavelengths by the light from the LED chip. For example, for an LED device generating white radiation by a combination of a blue LED and a fluorescent material that is excited by the light of the LED to generate yellow fluorescent light, a manner of mixing a small amount of fluorescent material generating red fluorescent light or a manner of combining an ultra-violet LED and three types of fluorescent material generating fluorescent light of respective colors, red, green and blue is preferable in terms of improvement in color rendition. Regarding these manners as well, a fluorescent material to be used is preferably in a particle form and preferably has the particle size within the range of ±50% of the median of the particle size of the fluorescent particles.

Method of Manufacturing the LED Device

A method of manufacturing an LED device here is a method of manufacturing the above-described LED device and characterized in that the method includes the steps of injecting a translucent resin including a fluorescent material into a package, applying vibrations to the package to form a flat layer including the fluorescent material on a bottom surface of the package, and heating to cure the translucent resin.

The layer including the fluorescent material may be formed on the bottom surface of the package by a method of injecting into the package the translucent resin into which the fluorescent material of a certain ratio is mixed and allowing the fluorescent material to settle before the translucent resin is heated to be cured. This method using the settlement is advantageous in that no special and costly apparatuses are necessary, the cost can be reduced, the manufacturing line can be simplified, and easy applicability to small-volume manufacturing of a wide variety of products.

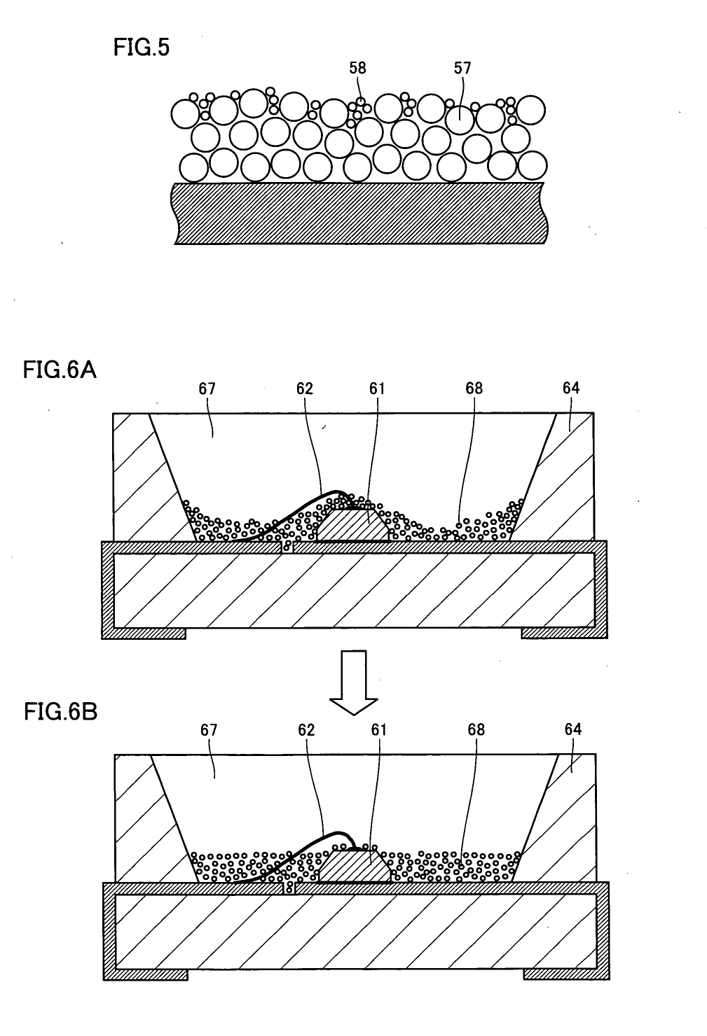

In the case where the fluorescent material is allowed to settle in the package, if the bottom surface of the package is not flat but uneven, the settlement with the uneven bottom as it is results in a non-uniform thickness of the resultant fluorescent material layer and the uneven surface. Consequently, the fluorescent material is not uniformly distributed in the package and the color mixture of the LED radiation and the fluorescent radiation degrades, which directly leads to variation in chromaticity of the color-mixed light. As an example, FIG. 6A shows that a fluorescent material 68 mixed into a translucent resin 67 is allowed as it is to settle in a package 64. The settling fluorescent material 68 accumulates along the unevenness portion including an LED chip 61, a metal wire 62 and the side surface of a package 64 for example, so that the top surface of the settlement layer is uneven.

According to the present invention, for the settlement in the package, vibrations are applied from the outside to the package so that the thickness of the fluorescent layer can be made uniform and the variation in chromaticity can be improved: A generally used translucent resin is an epoxy resin or silicon resin. Since the fluorescent material is higher in specific gravity than the translucent resin, vibrations, particularly fine vibrations applied in the direction parallel to the fluorescent layer cause fluorescent particles at a relatively high level in position to roll down and move to the lower level. At this time, movement of fluorescent particles in the opposite direction is unlikely to occur. Accordingly, the flat fluorescent layer as shown in FIG. 6B can be formed. The intensity of vibrations and the time required for the application of vibrations may appropriately be determined depending on the viscosity of an employed translucent resin and the weight of an employed fluorescent material for example. As a method of applying vibrations, any of methods including the usual one using a vibrating machine and the one using ultrasonic waves may be selected.

The step of injecting the translucent resin including the fluorescent material into the package more preferably includes the steps of allowing the fluorescent material to settle in the translucent resin, injecting the translucent resin including the settling fluorescent material, and injecting the translucent resin without fluorescent material into the package, since this approach improves color mixture and prevents variation in chromaticity.

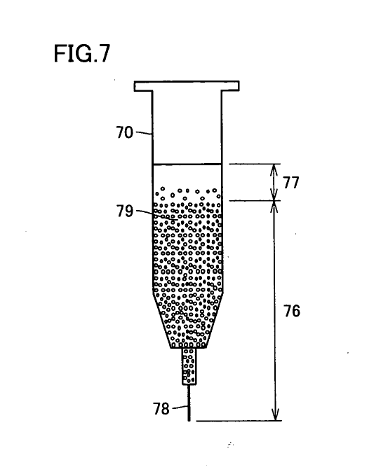

In the process of injecting into the package the translucent resin into which the granular fluorescent material is mixed, the fluorescent material is settling in a container used for the injection. Therefore, it is likely to occur that the concentration of the fluorescent material being injected into the package varies, which is likely to cause variation in chromaticity. In the process of injecting the resin, generally a container 70 in the shape as shown in FIG. 7 is used. To the front end of vessel 70, a hollow nozzle 78 is attached. In container 70, a translucent resin 79 containing a granular fluorescent material is included. When such vessel 70 is used to inject the resin into the package, it is difficult to evenly stir translucent resin 79 in container 70 including the resin in the tip of the front end of the container. Further, such factors as mixture of air bubbles into the translucent resin and extra process time of the stirring process are not negligible. In order to overcome these problems, the present invention allows the fluorescent material to settle in the translucent resin in the injection container in advance and then injects the translucent resin including the settling fluorescent material into the package. Accordingly, variation in concentration due to settlement of the fluorescent material in the injection process is eliminated and a constant amount of the fluorescent material can always be injected.

As shown in FIG. 7, the fluorescent-material-contained translucent resin 79 is supplied into injection container 70, injection nozzle 78 is directed downward, and the container is left in a stationary state. While the fluorescent material is settling in the translucent resin in the container, the container may be left in the stationary state for a sufficient time. Then, the settlement thereafter stops at some time so that the resin in the container is separated into a layer 76 in which the concentration of the fluorescent material is high and a supernatant layer 77 with almost no fluorescent material. In this state, injection into the package may be started. Then, while the resin in layer 76 is injected, the translucent resin with the fluorescent material that is always constant in concentration can be injected. After all of the resin in layer 76 is injected, the container may be replaced with another container left in a stationary state, without using supernatant layer 77. Thus, any loss in the manufacturing process can be eliminated. The boundary between layer 76 and layer 77 could be obscure due to the viscosity of an employed translucent resin or the specific gravity of an employed fluorescent material. This situation, however, can be addressed, in actual manufacturing, by determining in advance through experiments the level of layer 76 with which a stable concentration can be obtained and discarding supernatant layer 77 leaving some extra resin.

Further, since the concentration of the fluorescent material injected into the package is made further constant by the settlement, the above-described approach is advantageous in that any variation in mixture ratio between the translucent resin and the fluorescent material before being supplied into the injection container does not influence the concentration of the fluorescent material injected into the package. Here, due to the fact that the injected translucent resin contains the fluorescent material of a considerably high concentration, if this resin is used to fill the package, a too large amount of the fluorescent material is contained in the package and thus a desired chromaticity cannot be obtained. Therefore, the resin of high concentration is injected in small amount onto the bottom surface of the package, thereafter the same type of translucent resin is additionally injected and the amount of the translucent resin is adjusted to adjust the ratio of the fluorescent material. In this way, a desired chromaticity can be obtained. Preferably the additionally injected translucent resin does not contain the fluorescent material.

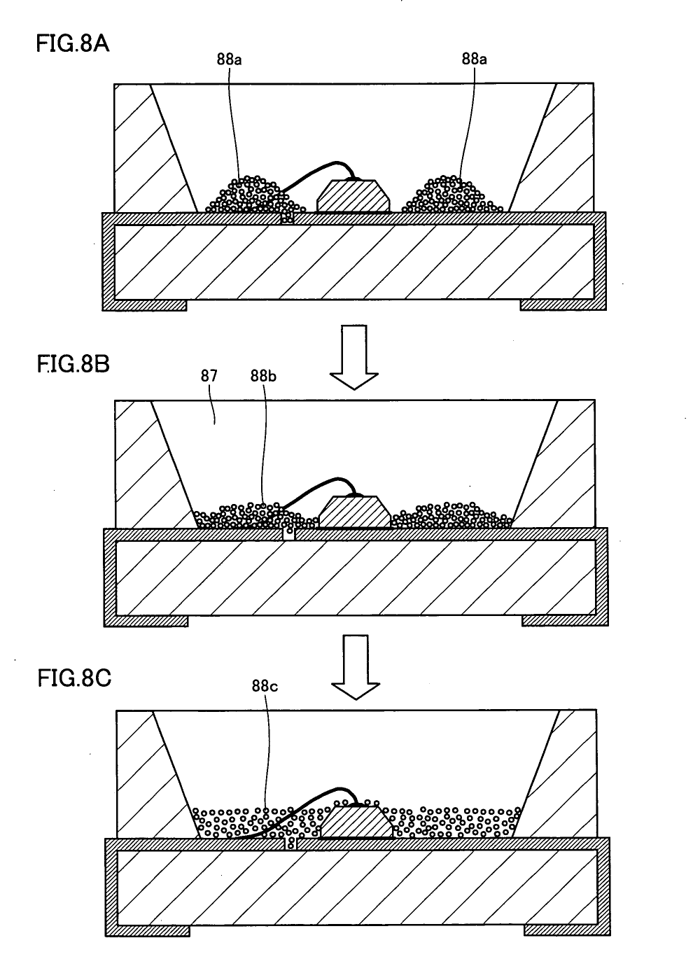

The translucent resin containing the fluorescent material that is injected first is considerably high in concentration of the fluorescent material. Therefore, the viscosity of the resin is also high. In this state, if the resin is injected onto the bottom surface of the package, a shape 88a as shown in FIG. 8A is generated. In this case, even if translucent resin 87 without fluorescent material is additionally injected, a shape 88b shown in FIG. 8B is left and thus a flat layer cannot be obtained. However, vibrations applied to the package after the injection can form a uniform and flat layer like the one with a shape 88c in FIG. 8C. The above-described manufacturing operations are all effective for improvements of variation in chromaticity.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A light-emitting diode device comprising, in a package:
a light-emitting diode chip;
a fluorescent material excited by light from the light-emitting diode chip to generate light with a wavelength different from that of the light from the light-emitting diode chip; and
a translucent resin holding the fluorescent material, wherein
said light-emitting diode chip includes a side-surface portion, a top-surface portion, a bottom-surface portion, and a light-emitting layer sandwiched between the top-surface portion and the bottom-surface portion, and
said fluorescent material in the translucent resin is provided in a layer form on a bottom surface of the package to entirely or partially cover the side-surface portion of the light-emitting diode chip.

2. The light-emitting diode device according to claim 1, wherein
said light-emitting diode chip has said side-surface portion with an inclined surface so that said light-emitting diode chip is convex toward an opening of the package.

3. The light-emitting diode device according to claim 2, wherein
said inclined surface of the light-emitting diode chip is located closer to the opening of the package relative to the light-emitting layer of the light-emitting diode chip.

4. The light-emitting diode device according to claim 1, wherein
said fluorescent material is in a form of particles and the size of the particles is selected to be within a range of ±50% of the median of the particle size of the particles.

5. The light-emitting diode device according to claim 1, wherein
said fluorescent material is comprised of at least two types of fluorescent material emitting light with respective wavelengths different from each other by the light from the light-emitting diode chip.

6. A light-emitting diode device comprising, in a package:
a light-emitting diode chip;
a fluorescent material excited by light from the light-emitting diode chip to generate light with a wavelength different from that of the light from the light-emitting diode chip; and
a translucent resin holding the fluorescent material, wherein
said light-emitting diode chip includes a side-surface portion, a top-surface portion, a bottom-surface portion, and a light-emitting layer sandwiched between the top-surface portion and the bottom-surface portion, and
said fluorescent material in the translucent resin is provided on a bottom surface of the package and in a layer form with a uniform thickness from the bottom surface.

7. The light-emitting diode device according to claim 6, wherein
said light-emitting diode chip has said side-surface portion with an inclined surface so that light-emitting diode chip is convex toward an opening of the package.

8. The light-emitting diode device according to claim 7, wherein
said inclined surface of the light-emitting diode chip is located closer to the opening of the package relative to the light-emitting layer of the light-emitting diode chip.

9. The light-emitting diode device according to claim 6, wherein
said fluorescent material is in a form of particles and the size of the particles is selected to be within a range of ±50% of the median of the particle size of the particles.

10. The light-emitting diode device according to claim 6, wherein
said fluorescent material is comprised of at least two types of fluorescent material emitting light with respective wavelengths different from each other by the light from the light-emitting diode chip.

11. The light-emitting diode device according to claim 6, wherein
the layer including said fluorescent material in the translucent resin has its thickness smaller than the thickness from the bottom-surface portion to the top-surface portion of said light-emitting diode chip and larger than the thickness from the bottom-surface portion to the light-emitting layer of said light-emitting diode chip.

12. A light-emitting diode device comprising, in a package:
a light-emitting diode chip;
a fluorescent material excited by light from the light-emitting diode chip to generate light with a wavelength different from that of the light from the light-emitting diode chip; and
a translucent resin filling the package, wherein
said light-emitting diode chip includes a side-surface portion, a top-surface portion, a bottom-surface portion, and a light-emitting layer sandwiched between the top-surface portion and the bottom-surface portion, and
said translucent resin includes one translucent resin layer provided on the bottom surface of said package and in a layer form and containing a fluorescent material and another translucent resin layer provided adjacent to the translucent resin layer and closer to an opening of the package and containing no fluorescent material.

13. The light-emitting diode device according to claim 12, wherein
said light-emitting diode chip has said side-surface portion with an inclined surface so that said light-emitting diode chip is convex toward an opening of the package.

14. The light-emitting diode device according to claim 13, wherein
said inclined surface of the light-emitting diode chip is located closer to the opening of the package relative to the light-emitting layer of the light-emitting diode chip.

15. The light-emitting diode device according to claim 12, wherein
said fluorescent material is in a form of particles and the size of the particles is selected to be within a range of ±50% of the median of the particle size of the particles.

16. The light-emitting diode device according to claim 12, wherein
said fluorescent material is comprised of at least two types of fluorescent material emitting light with respective wavelengths different from each other by the light from the light-emitting diode chip.

17. The light-emitting diode device according to claim 12, wherein
the layer including said fluorescent material in the translucent resin has its thickness smaller than the thickness from the bottom-surface portion to the top-surface portion of said light-emitting diode chip and larger than the thickness from the bottom-surface portion to the light-emitting layer of said light-emitting diode chip.

18. A method of manufacturing the light-emitting diode device as recited in claim 1, comprising the steps of:
injecting a translucent resin including a fluorescent material into a package;
applying vibrations to said package to form a flat layer including the fluorescent material on a bottom surface of the package; and
heating to cure said translucent resin.

19. The method of manufacturing the light-emitting diode device according to claim 18, wherein
said step of injecting the translucent resin including the fluorescent material into the package includes the steps of:
leaving an injection container filled with said fluorescent material and said translucent resin in a stationary state to allow the fluorescent material to settle in the translucent resin; and
injecting said translucent resin including the settling fluorescent material into the package.

20. A method of manufacturing the light-emitting diode device as recited in claim 6, comprising the steps of:
injecting a translucent resin including a fluorescent material into a package;
applying vibrations to said package to form a flat layer including the fluorescent material on a bottom surface of the package; and
heating to cure said translucent resin.

21. The method of manufacturing the light-emitting diode device according to claim 20, wherein
said step of injecting the translucent resin including the fluorescent material into the package includes the steps of:
leaving an injection container filled with said fluorescent material and said translucent resin in a stationary state to allow the fluorescent material to settle in the translucent resin; and
injecting said translucent resin including the settling fluorescent material into the package.

22. A method of manufacturing the light-emitting diode device as recited in claim 12, comprising the steps of:
injecting a translucent resin including a fluorescent material into a package;
applying vibrations to said package to form a flat layer including the fluorescent material on a bottom surface of the package; and
heating to cure said translucent resin.

23. The method of manufacturing the light-emitting diode device according to claim 22, wherein
said step of injecting the translucent resin including the fluorescent material into the package includes the steps of:
leaving an injection container filled with said fluorescent material and said translucent resin in a stationary state to allow the fluorescent material to settle in the translucent resin; and
injecting said translucent resin including the settling fluorescent material into the package.
